(19) United States
(12) Patent Application Publication
(10) Pub. No.: US 2003/0227766 A1
(43) Pub. Date: Dec. 11, 2003

(54) Keypad lighting system for a security system communication unit

(76) Inventors: Wayne C. Hom, Rancho Santa Margarita, CA (US); Hagop Sakadjian, Mission Viejo, CA (US)

Correspondence Address: LEVIN INTELLECTUAL PROPERTY GROUP, 384 FORESET AVE, SUITE 13, LAGUNA BEACH, CA, 92651, US

(21) Appl. No.: 10/167,721

(22) Filed: Jun. 11, 2002

(51) Int. Cl. G01D 11/28; G09G 5/00

(52) U.S. Cl. 362/23

(57) ABSTRACT

An illumination system for a keypad of a security system communication unit is disclosed in which LED's are embedded in a light dispersing medium around the peripheral edge of the keypad in a plane offset and adjacent to the plane of the keypad so that the light from the LED's is dispersed across the keypad in an even fashion.

### FIELD OF THE INVENTION

The present invention relates to security system communication units and more particularly a means for illuminating the keypad of a security system communication unit.

### BACKGROUND OF THE INVENTION

Security systems that limit access to a restricted area, such as gated community, apartment or business complex have become commonplace. Often the movable gates or barriers have no attendant to check individuals arriving at the barrier and then open the barrier to allow the individual to enter if they have proper authorization. In such situations, a communication unit is provided so the individual seeking entry can call someone in a unit within the restricted area and have them open the barrier with a remote signal. On the other hand the individual seeking entry into the restricted area may enter an access code on the keypad if they are an occupant of a unit in the complex or otherwise has the code because of preauthorization to enter. These security system communication units are often located in remote areas and exposed to the elements.

Communication units of security systems described above typically require a means to illuminate the keypad. At night or even on overcast days, given the location of the unit, the keypad and the keys and numbers on the keys may not be easy to see. This is due to the fact that the communication unit may be located in an entryway or some other exposed location outside where the available light may be limited or nonexistent. Incandescent lights are used to illuminate the keyboard of the communication unit. These incandescent lights are placed at a position adjacent to the keypad to provide the light. However, incandescent lights present a number of problems. Their short life typically requires several service calls during the life of the communication unit to replace ones that have burned out. The filament of an incandescent light can, given its fragility, break if inadvertently jarred or hit. Additionally, the power needs of incandescent lights require a special transformer located within a short distance of the light plus a significant power source. Incandescent lights also generate a lot of heat that, depending on the application, requires some means to dissipate the heat generated. Generally, the communication units must be seated to protect the internal parts from exposure to the elements and prevent tampering. Consequently, the temperatures within the unit can reach unacceptable levels during hot sunny days as a result of the heat generated by the incandescent lights. Thus, this often requires the inclusion of some means to cool the unit. Another problem with incandescent lights is that the light provided tends not to be uniformly dispersed in that there are varying bright and shadow areas cast across the keyboard. The uneven dispersal of light across the keypad, at a minimum, is annoying and at worst can make it hard to see all of the keys of the keypad properly.

One of the problems in designing a remote security communication unit, such as a security gate communication unit, is the need to have a rugged device that can withstand substantially more abuse than the typical telephone is subjected to. The standard configurations of LED's used on telephones and cell phones if used in a security unit communications system would leave the unit open to damage given the extensive and heavy usage they are subjected to. It would also make the security communication unit susceptible to vandalism. Given the remote location and/or unattended location of the security system communication unit, it will attract vandalism. Thus, the unit must be able to withstand a certain level of vandalism and heavy and sometimes abusive use and continue to function without damage. A frustrated individual attempting to contact someone on the unit may become abusive and take their frustration out on the communication unit. Additionally, the unit must present a rugged and invulnerable appearance to dissuade potential vandals. As is well known in the security industry, appearances can make a difference and if the unit appears to be invulnerable to damage it will dissuade vandalism against the communication unit. On the other hand if a unit appears to be susceptible to damage, it may attract vandalism.

Light emitting diodes (LED's) have been used for at least twenty years to light the keypads of telephones and cell phones. Typically the LED's are positioned underneath the keypad and provide light by projecting light up through a translucent keypad. In other arrangements the LED's placed to the side or under the keypad and the light from the LED's is projected to the keypad by some type of light pipe arrangement. The problem with attempting to use LED's to illuminate a keypad of a security unit is the need to generate a sufficient amount of light to allow the keypad to be seen while still provide a rugged and durable unit that will not be the subject to inadvertent damage or vandalism. The designs used in telephones and cell phones that typically place the LED's in the keypad create a honeycomb effect in the keypad that make the keypad vulnerable to damage when used on a public communication unit in an unattended location as discussed at length above. To date there has been a failure to design a security communication unit that capitalizes on the advantages of the low power usage of LED's while providing a rugged communication unit that can withstand substantial inadvertent or intentional abuse and not be affected by it and at the same time providing sufficient light to illuminate the keypad.

Thus, what is needed is a security system communication unit that incorporates the power consumption advantages of LED's in providing a light source to illuminate the keypad of the communication unit. Such an arrangement of LED's would have to provide sufficient and uniformly dispersed light to the keypad while being incorporated into the design of the communication unit so that it provides the appearance of invulnerability and can withstand substantial inadvertent or intentional abuse and not only not be damaged, but not show damage.

### SUMMARY

It is an objective of the present invention to provide a LED based lighting arrangement for a keypad of a security system communication unit that provides an even dispersal of light a across the keypad. It is a further objective of the present invention to provide an LED based lighting system that is rugged, tamper proof, and able to withstand substantial abuse and vandalism and still maintain an appearance of not having sustained any damage.

The present invention accomplishes these and other objectives by providing a security communication unit keypad illumination system with a plurality of LED's positioned in a peripheral array around a keypad in a plane offset from a plane of the keypad, the peripheral array of LED's being coupled with a light dispersing medium that spreads the light from said LED's out across the keypad, said security unit being encased in a strong case and the illumination system being shielded by a portion of the case of the security communication unit. In a further aspect, the LED's can be embedded in light dispersing medium. In yet another aspect of the present invention the light-dispersing medium can provide support for the LED's to maintain them in the proper position with respect to the keypad and the light-dispersing medium can be a plastic like material. In a further aspect of the present invention the communication unit is encased in durable and strong case made of stainless steel or similar material and the LED's and the light dispersing medium are protected by the case with only one surface of the light dispersing medium exposed along a surface of the light dispersing medium that is perpendicular to the plane of the keypad and surrounds the periphery of the keypad to disperse the light across the keypad.

### BRIEF DESCRIPTION OF THE DRAWINGS

The invention will be better understood by an examination of the following description, together with the accompanying drawings, in which:

FIG. 1 is a front raised view of security system remote communication unit that incorporates the present invention;

FIG. 2 is an enlarged front raised view of the keypad area of the unit depicted in FIG. 1;

FIG. 3 is a view of the keypad of the communication unit with the front faceplate of the unit removed to expose the light dispersing and transmissive medium in which the LED's are embedded;

FIG. 4 is a cross sectional view along line 4-4 in FIG. 3;

FIG. 5 is a diagram of one way for electrically connecting the LED's embedded in the light dispersing and transmissive medium; and

FIG. 6 is a perspective view of the light dispersing and transmissive medium that the LED's are embedded in.

### DETAILED DESCRIPTION OF THE PREFERRED EMBODIMENT

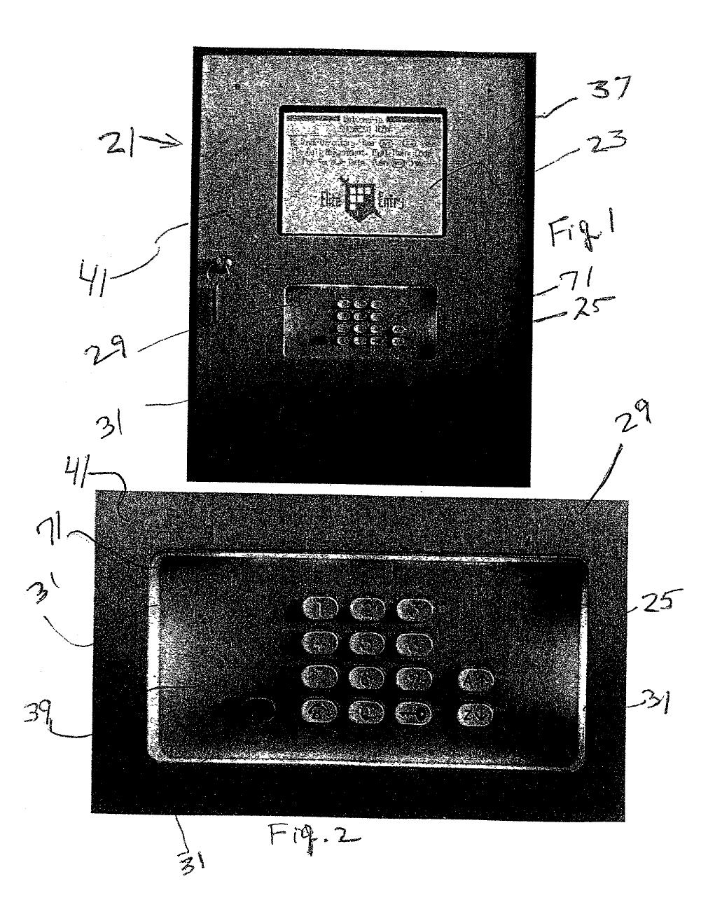

The invention as depicted in FIG. 1 consists of a security gate communication unit 21 that has a visual display 23 and a keypad 25. The keypad 25, also depicted in FIG. 2 in an enlarged view, is located in a depression 29 on the security communication unit 21. An array of LED's is placed around the periphery 31 of the depression 29. The array of LED's is in a plane offset from the plane of keypad 25 so light from the LED's projects out across the face of keypad 25. This enables one at night to clearly see the keys of the keypad 25.

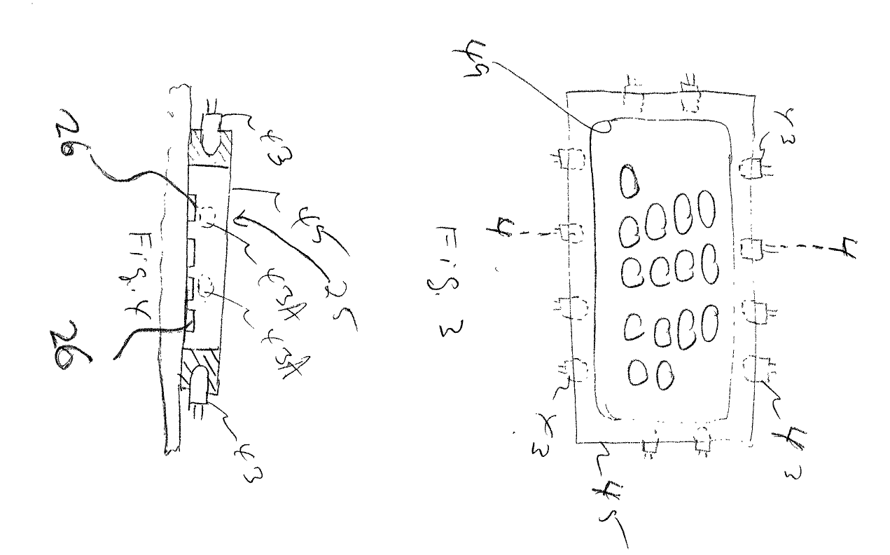

FIG. 3 provides a view of keypad 25 with front faceplate 41 of case 37 removed to reveal the positions of LED's 43. LED's 43 are embedded in a light dispersing and transmissive medium 45. The embedded portion of the LED's being depicted in dotted outline form. In a preferred embodiment this material will be a translucent and light dispersive plastic like material. Light transmitting and dispersing medium 45 is in the shape of a rectangular ring that surrounds keypad 25 and when installed behind faceplate 41 (FIG. 1) is only visible along its inside edge 49. FIG. 4 is a cross sectional view of light transmitting and dispersing medium 45 along line 4-4 in FIG. 3. LED's 43 are depicted embedded in light transmitting and dispersing medium 45 as well as LED's 43A shown in dotted outline form. Keys 26 of keypad 25 are also depicted.

The unit depicted in FIG. 1 is a rugged unit designed for years of use in a remote and exposed location. Case 37 that encloses the unit in one preferred embodiment is made of heavy gauge stainless steel. Back plate 39 (FIG. 2) of keypad 25 is likewise a sheet of heavy gauge stainless steel. Given the extensive use that keypad will undergo over several years in an exposed location the unit must have substantial durability to withstand the use and abuse it will experience without the need for repair or service.

Use of LED's provides several distinct advantages over incandescent lights. LED's do not generate the heat that incandescent lights do and in fact are cool to the touch; thus, embedding the LED's in a light dispersing and transmissive medium 45 does not create any problems white enhancing the illumination characteristics of the LED's. This aspect eliminates shadows and non-uniformly illuminated areas typical of incandescent lights and thus makes it much easier to clearly see the keyboard. The LED's consume significantly less power than incandescent lights. Thus, LED's do not need special transformers and power supplies to operate. In fact, the LED's can be connected in series as depicted in FIG. 5 and with each LED consuming 1.2 volts and thus a 12 volt power supply is sufficient to operate all ten LED's depicted in FIG. 5. All ten LED's can be powered with less than 20 milliamperes (mA) whereas one or two incandescent lights would require a minimum of 80 mA. In FIG. 5 the LED's 43 are connected in series by line 54 that connects the LED's to power supply 57. Naturally, if the entire 12 volts were not dropped across the 10 LED's, a resistor of appropriate value would have to be added to the circuit. The LED's could also be connected in parallel to the power supply in the usual fashion. In such an arrangement each LED would be individually connected to the power supply with resistors of appropriate value.

LED's have significantly longer life than incandescent lights. Whereas the typical incandescent light might only have a useful life of 2000 to 5000 hours, the typical LED has a useful life in excess of 100,000 hours. This fact essentially eliminates the need for service calls to replace LED's as opposed to incandescent lights that require frequent replacement.

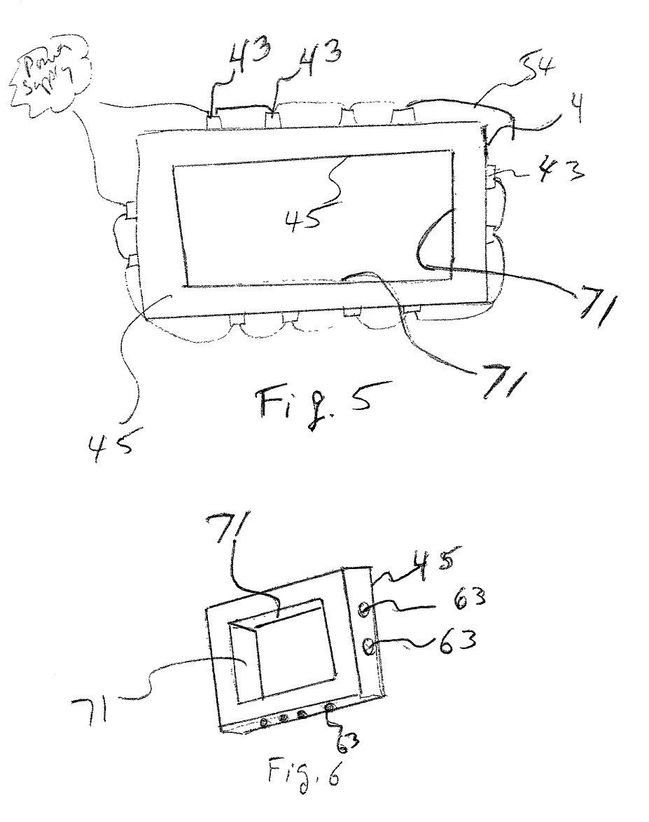

FIG. 6 provides a perspective view of the light-dispersing medium 45 in which the LED's are embedded. Light dispersing medium 45 provides a means of securing and holding in place the LED's as well as helping disperse the light from the LED's. The recesses or holes 63 into which the LED's are inserted are depicted. Light-dispersing medium 45 actually serves two purposes in the preferred embodiment of the invention depicted. It provides support for and a means of positioning the LED's in relation to the keypad as well as helping to disperse the light across the keypad in an even fashion. Additionally, in the preferred embodiment light dispersing medium 45 is made up of transparent or translucent plastic like material. This provides protection for the LED's from impact some one or something hitting the exposed surface of light dispersing medium 45. Additionally, since in the preferred embodiment edge 71 is exposed when the illumination unit consisting of medium 45 and LED's 43 are installed this limits exposure of the illumination unit to its strongest surface. As previously noted faceplate 41 (FIGS. 1 and 2) covers the entire communication unit 21.

While the invention has been particularly shown and described with reference to a preferred embodiment thereof, it will be understood by those skilled in the art that various changes in form and detail may be made to it without departing from the spirit and scope of the invention.

We claim:

1. A security communication unit keypad illumination system comprising:
a plurality of LED's positioned in a peripheral array around a keypad in a plane offset from a plane of the keypad, said peripheral array of LED's being coupled with a light dispersing medium that spreads said light from said LED's out across said keypad, said security unit being encased in a strong case and said illumination system being shielded by a portion of said case of said security communication unit.

2. The system of claim 1 wherein said LED's are superbright LED's.

3. The system of claim 1 wherein said LED's are electrically connected in series to a common power source.

4. The system of claim 1 wherein said light dispersing medium is a translucent plastic like material.

5. The system of claim 1 wherein said LED's being coupled with a light dispersing medium comprises imbedding the LED's in the light dispersing medium.

6. The system of claim 1 wherein said case is made of heavy gage stainless steel.

7. The system of claim 1 wherein said illumination system is only exposed on one light transmissive surface that forms a peripheral wall perpendicular to the plane of the keypad and surrounding the keypad to thereby project light across the keypad.

8. A security communication unit keypad illumination system comprising:
a plurality of LED's positioned in a peripheral array around a keypad in a plane offset from a plane of the keypad, said peripheral array of LED's being embedded in a light dispersing medium that spreads said light from said LED's out across said keypad.

9. The system of claim 8 wherein said LED's are superbright LED's.

10. The system of claim 8 wherein said LED's are electrically connected in series to a common power source.

11. The system of claim 8 wherein said light dispersing medium is a translucent plastic light material.
